(19) United States
(12) Patent Application Publication
(10) Pub. No.: US 2014/0286192 A1
(43) Pub. Date: Sep. 25, 2014

(54) COMMUNICATION STATION AND COMMUNICATION DEVICE FOR INTERWORKING BETWEEN DIFFERENT RADIO TECHNOLOGIES WITH ASSISTANCE INFORMATION

(71) Applicant: ACER INCORPORATED, New Taipei City (TW)

(72) Inventor: Hung-Yu WEI, New Taipei City (TW)

(73) Assignee: ACER INCORPORATED, New Taipei City (TW)

(21) Appl. No.: 14/166,401

(22) Filed: Jan. 28, 2014

Related U.S. Application Data
(60) Provisional application No. 61/804,764, filed on Mar. 25, 2013.

(51) Int. Cl. H04W 84/18

(52) U.S. Cl. CPC H04W 84/18
USPC 370/254

(57) ABSTRACT

A communication station includes a transceiving circuit, a memory circuit and a processing circuit. The transceiving circuit communicates with a communication device by utilizing a first radio access technology. The memory circuit stores the interworking assistance information of a neighboring communication station. The processing circuit configures the transceiving circuit to transmit the interworking assistance information of the neighboring communication station when the communication device is associated with the communication station. The neighboring communication station communicates with the communication device by utilizing a second radio access technology. The communication range of the communication station overlaps the communication range of the neighboring communication station. The interworking assistance information of the neighboring communication station includes at least one of a co-located indication information, a backhaul link condition information, an operator information, a security information, a loading condition information, a range information, a pricing information and a network configuration information.

### CROSS-REFERENCE TO RELATED APPLICATIONS

This application claims the benefit of priority to U.S. Provisional Application Ser. No. 61/804,764, filed on Mar. 25, 2013; the entirety of which is incorporated herein by reference for all purposes.

### BACKGROUND

The disclosure generally relates to communication devices and, more particularly, to the communication devices with the interworking capability.

Along with the advances in the mobile communication technologies, people are getting used to handling more and more tasks on the mobile communication devices, e.g., surfing the Internet, watching videos, and telephone conversations. The prevalence of the mobile communication devices and the accompanied frequency bandwidth requirement, however, introduce challenges for the network operators.

The base station of the mobile network may only accommodate a certain number of user equipment within a certain communication range. Therefore, many researches have been carried on to increase the amount of user equipment in a certain area, to balance the load in the communication network, to improve the communication quality, etc. For example, some researches propose that the communication network provides both the 3GPP radio access technologies and the wireless local area network (WLAN) radio access technologies for improving the system performance. The mobile communication devices arbitrarily and blindly choose the radio access technology for performing communications. Therefore, the network resources still may not be utilized efficiently and effectively even with the interworking of the 3GPP radio access technologies and the WLAN radio access technologies.

### SUMMARY

In view of the foregoing, it may be appreciated that a substantial need exists for methods and apparatuses that mitigate or reduce the problems above.

An example embodiment of a communication station is disclosed, comprising: a transceiving circuit configured to operably communicate with a communication device by utilizing a first radio access technology (RAT); a memory circuit configured to operably store one or more interworking assistance information of a neighboring communication station; and a processing circuit, coupled with the transceiving circuit and the memory circuit, configured to operably configure the transceiving circuit to transmit the interworking assistance information of the neighboring communication station when the communication device is associated with the communication station; wherein the neighboring communication station communicates with the communication device by utilizing a second RAT; at least part of a communication range of the communication station overlaps at least part of a communication range of the neighboring communication station; and the interworking assistance information of the neighboring communication station comprises at least one of a co-located indication information, a backhaul link condition information, an operator information, a security information, a loading condition information, a range information, a pricing information and a network configuration information.

Another example embodiment of a communication device is disclosed, comprising: a first transceiving circuit configured to operably communicate with a first communication station by utilizing a first radio access technology (RAT); a second transceiving circuit configured to operably communicate with a second communication station by utilizing a second RAT; and a processing circuit, coupled with the first transceiving circuit and the second transceiving circuit, configured to operably configure the first transceiving circuit to receive one or more interworking assistance information of the second communication station from the first communication station when the communication device is associated with the first communication station; wherein at least part of a communication range of the first communication station overlaps at least part of a communication range of the second communication station; and the interworking assistance information of the second communication station comprises at least one of a co-located indication information, a backhaul link condition information, an operator information, a security information, a loading condition information, a range information, a pricing information and a network configuration information.

Both the foregoing general description and the following detailed description are examples and explanatory only, and are not restrictive of the invention as claimed.

### BRIEF DESCRIPTION OF THE DRAWINGS

FIG. 1 shows a simplified functional block diagram of a communication system according to one embodiment of the present disclosure

FIG. 2 shows a simplified flowchart of an interworking method according to one embodiment of the present disclosure.

### DETAILED DESCRIPTION

Reference is made in detail to embodiments of the invention, which are illustrated in the accompanying drawings. The same reference numbers may be used throughout the drawings to refer to the same or like parts, components, or operations.

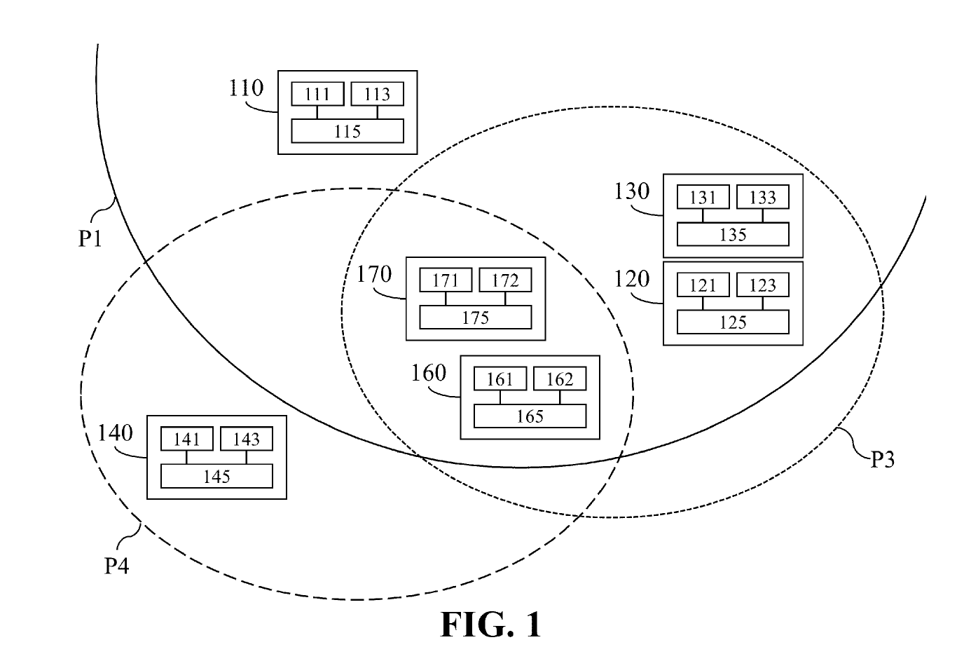

FIG. 1 shows a simplified functional block diagram of a communication system 100 according to one embodiment of the present disclosure. In this embodiment, the communication system 100 comprises four communication stations 110-140 and two communication devices 160 and 170. For the purposes of conciseness and clear explanation, some components and connections of the communication system 100 are not shown in FIG. 1.

In the following embodiments, the communication stations 110-140 may respectively communicate with the communication device by utilizing at least one of a first radio access technology (RAT) and a second RAT. The first RAT may be configured to utilize one or more wireless wide area network (WWAN), wireless metropolitan area network (WMAN), or other suitable radio access technologies (RATs) with a wider communication range, e.g., WiMAX, GSM, UMTS, HSPA, LTE, LTE-Advanced and other 3GPP RATs. The second RAT may be configured to utilize one or more wireless local area network (WLAN), or other suitable RATs with a shorter communication range (compared with the first RAT), e.g., IEEE 802.11 series RATs.

Moreover, in the following embodiments, the communication stations 110-140 are the neighboring communication stations to one another. At least part of the communication range of a communication station overlaps at least part of the communication ranges of its neighboring communication station. As shown in FIG. 1, the communication range P1 of the communication station 110 overlaps the communication range P3 of the communication station 130 and the communication range P4 of the communication station 140.

The communication station 110 comprises a transceiving circuit 111, a memory circuit 113, and a processing circuit 115. The communication station 120 comprises a transceiving circuit 121, a memory circuit 123, and a processing circuit 125. The communication station 130 comprises a transceiving circuit 131, a memory circuit 133, and a processing circuit 135. The communication station 140 comprises a transceiving circuit 141, a memory circuit 143, and a processing circuit 145.

The transceiving circuits 111, 121, 131 and 141 may respectively comprise the antenna, the modulator/demodulator, analog signal processing circuits, and/or digital processing circuits for performing communications with communication devices. The transceiving circuits 111 and 121 are configured to operably communicate with communication devices by utilizing the first RAT. The transceiving circuits 131 and 141 are configured to operably communicate with communication devices by utilizing the second RAT.

The memory circuit 113, 123, 133 and 143 may be respectively realized with the volatile memory unit and/or the non-volatile memory unit, e.g. registers, hard drives, and flash memory devices. The memory circuits 113, 123, 133 and 143 are configured to operably store one or more interworking assistance information of the neighboring communication station(s). For example, the memory circuit 113 of the communication station 110 may store the interworking assistance information of at least one of the neighboring communication stations 120, 130 and 140.

The processing circuit 115, 125, 135 and 145 may be realized with the microprocessor, the network processor, analog signal processing circuits, digital signal processing circuits, and/or other suitable processing circuits. The processing circuits 115, 125, 135 and 145 are respectively coupled with the transceiving circuits 111, 121, 131 and 141 and the memory circuits 113, 123, 133 and 143 for performing suitable operations.

For the purpose of conciseness, in the following embodiments, the first RAT is configured to be at least one of the 3GPP RATs and the second RAT is configured to be at least one of the IEEE 802.11 series RATs. Thus, the communication stations 110 and 120 are configured to be 3GPP base stations (BS). The communication station 130 and 140 are configured to be IEEE 802.11 wireless access points (APs). Moreover, the communication stations 120 and 130 are co-located in substantially the same location.

In this embodiment, the co-located communication stations 120 and 130 are illustrated to be two functional blocks in FIG. 1. In another embodiment, the communication stations 120 and 130 may be realized with a single communication station comprising a transceiving circuit for communicating by utilizing the first RAT and another transceiving circuit for communicating by utilizing the second RAT. Moreover, there may be one or more memory circuits in the single communication station for performing the functions of the memory circuits 123 and 133, and one or more processing circuits for performing the functions of the processing circuits 125 and 135.

The communication device 160 comprises a first transceiving circuit 161, a second transceiving circuit 162 and a processing circuit 165. The communication device 170 comprises a first transceiving circuit 171, a second transceiving circuit 172 and a processing circuit 175.

The transceiving circuits 161, 162, 171 and 172 may respectively comprise the antenna, the modulator/demodulator, analog signal processing circuits, and/or digital processing circuits for performing communications with communication stations. The transceiving circuits 161 and 171 are configured to operably communicate with communication stations by utilizing the first RAT. The transceiving circuits 162 and 172 are configured to operably communicate with communication stations by utilizing the second RAT.

The processing circuit 165 and 175 may be realized with the microprocessor, the network processor, analog signal processing circuits, digital signal processing circuits, and/or other suitable processing circuits. The processing circuits 165 and 175 are respectively coupled with the transceiving circuit 161, 162, 171 and 172 for performing suitable operations.

The communication stations 110, 120, 130 and 140 are respectively coupled to one another through the network (not shown in FIG. 1). The network may be realized with one or more wired networks and wireless networks, and may comprise the backhaul network, the core network, the gateway, servers and other network equipment (not shown in FIG. 1). For example, in one embodiment, the communication station 110 may be coupled to the communication stations 120 and 130 through a direct link of a coaxial cable, an Ethernet cable, a data bus, etc. In another embodiment, the communication station 110 may be coupled to the communication station 140 through a gateway and an interworking server.

In order to improve the interworking performance of the communication system 100, the communication stations may transmit the interworking assistance information of one or more neighboring communication stations to a communication device for assisting the interworking operations of the communication device. The communication device may therefore perform interworking related operations more effectively and efficiently. The interworking assistance information of the neighboring communication station may comprise a co-located indication information, a backhaul link condition information, an operator information, a security information, a loading condition information, a range information, a pricing information, a network configuration information, etc.

The co-located indication information may be configured to indicate whether the neighboring communication station is able to communicate by utilizing both the first RAT and the second RAT. For example, the communication stations 120 and 130 are deployed at the same location or within a close distance. The co-located indication information of the communication station 120 and the neighboring communication station 130 may therefore be configured to indicate the ability to communicate by utilizing both the first RAT and the second RAT.

The co-located indication information may further comprise a correlation indicator for indicating whether the first RAT and the second RAT are correlated. For example, when the first RAT signal and the second RAT signal are highly correlated, the correlation indicator may be configured to be 1. Thus, there is higher probability that the communication stations 120 and 130 are deployed at the same location or within a close distance.

The backhaul link condition information may be configured to indicate the link condition status between a communication station and its neighboring communication station. For example, the backhaul link condition information may indicate the communication stations 110 and 140 are connected through a low latency link or a high latency link

The operator information may be configured to indicate the interworking agreement information between a communication station and its neighboring communication station, the operator of the neighboring communication station, etc. For example, the interworking agreement information may comprise the existence of the interworking agreement, the type of the interworking agreement, the pricing configuration of the interworking agreement, the security configuration of the interworking agreement, etc. The operator of the neighboring communication station may also be represented by indicating whether the communication station and its neighboring communication station are operated by the same operator.

The security information may be configured to indicate whether the neighboring communication station is in the same security domain, whether the neighboring communication station is trustworthy, the security level of the neighboring communication station, the authentication setting of the neighboring communication station, the security setting of the neighboring communication station, etc. For example, the security information may indicate the neighboring communication station supports the EAP-SIM authentication.

The loading condition information may be configured to indicate the load condition of the neighboring communication station, the supported QoS (Quality of Service) type of the neighboring communication station, the communication station suggestion information, etc. For example, the loading condition information may indicate that the neighboring communication station 130 is lightly loaded and the neighboring communication station 140 is heavily loaded. The load condition of the neighboring communication may be configured to indicate the aggregated load of the neighboring communication station or the load of a sub-system of the neighboring communication station (e.g., the load of a sub-channel, the load of a sub-band, the load of uplink communications and the load of downlink communications). The communication station suggestion information may be configured to indicate a suggested communication station for the communication device to perform the interworking operations.

The range information may be configured to indicate the geographical relationship between a communication station and its neighboring communication station, the transmission range information of the neighboring communication station, the cell type of the neighboring communication station, etc. For example, the transmission range information of the neighboring communication station may be configured to be a factor of a predetermined range. In another embodiment, the geographical relationship between a communication station and its neighboring communication station may be configured to indicate the distance between the communication station and its neighboring communication station.

The pricing information may be configured to indicate the pricing rule of the neighboring communication station, the discount information of the neighboring communication station, the promotion information of the neighboring communication station, the joint pricing between the communication station and its neighboring communication station, etc.

The network configuration information may be configured to indicate the carrier frequency of the neighboring communication station, the channel information of the neighboring communication station, the supported radio access technology of the neighboring communication station, the identification of the neighboring communication station, the timing information of the neighboring communication station, the frame configuration of the neighboring communication station, etc. For example, the channel information of the neighboring communication station may indicates the supported channels, the supported bands, the good quality channels, the good quality bands, etc. The supported radio access technology of the neighboring communication station may configured to be IEEE 802.11a, IEEE 802.11b, IEEE 802.11g, IEEE 802.11n, IEEE 802.11ac, HSPA, LTE, LTE-Advanced, etc. The identification of the neighboring communication station may be configured to be the MAC address, the cell ID, the ESS ID, the BSS ID, etc. The timing information of the neighboring communication station may be configured to be the beacon period, the timing offset, etc. The frame configuration of the neighboring communication station may be configured to be the TDD uplink subframe setting, the TDD downlink subframe setting, etc.

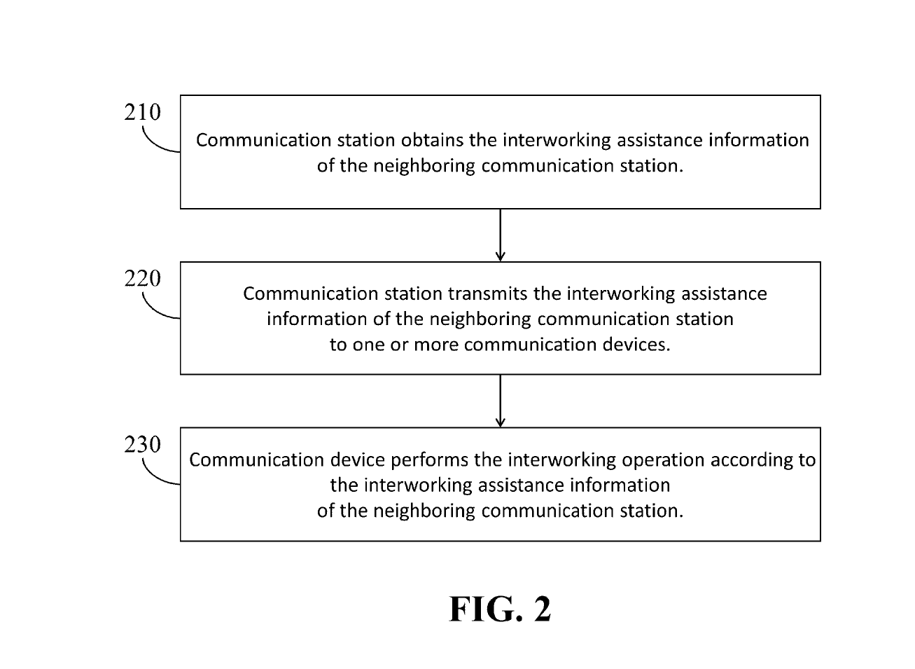

FIG. 2 shows a simplified flowchart of an interworking method according to one embodiment of the present disclosure. The operations of the communication system 100 are further explained below with FIGS. 1 and 2.

In the operation 210, a first communication station obtains the interworking assistance information of a neighboring second communication station, and stores in the memory circuit of the first communication station. The communication station may obtain the interworking assistance information from one or more neighboring communication stations simultaneously or at different time points. Moreover, the neighboring communication station has at least one RAT different from the first RAT of the first communication station.

For example, the communication station 110 (which utilizes the first RAT) may obtain the interworking assistance information from at least one of the neighboring communication stations 130 and 140 (which utilize the second RAT). In one embodiment, the communication station 110 may receive the interworking assistance information from other neighboring communication stations through the network. In another embodiment, the communication station 110 may also request other neighboring communication stations to transmit their interworking assistance information. In another embodiment, the interworking assistance information may be stored in the memory circuit 113 of the communication station 110 by the engineer when installing the communication station 110.

In the operation 220, the first communication station transmits the interworking assistance information of the neighboring communication station to one or more communication devices. In one embodiment, the first communication station may transmit the interworking assistance information of the neighboring communication station upon a request from a communication device. In another embodiment, the first communication station may also transmit the interworking assistance information to multiple communication devices associated with the first communication station. In another embodiment, the first communication station may also transmit the interworking assistance information to the communication devices associated with the first communication station and/or the communication devices not associated with the first communication station.

For example, the communication device 160 is associated with the communication station 110 (a 3GPP BS). The communication station 110 may transmit the interworking assistance information to the communication device 160 by utilizing RRC (radio resource control) Connection Reconfiguration messages, RRC Connection Configuration messages, UE (user equipment) Interworking Assistance Information messages, other suitable RRC messages or other suitable unicast communications of the 3GPP RATs.

In another embodiment, the communication devices 160 and 170 are associated with the communication station 110 (a 3GPP BS). The communication station 110 may transmit the interworking assistance information to the communication devices 160 and 170 by utilizing the SIB (system information block), the Broadcast Channel, other suitable multicast communications or other suitable broadcast communications of the 3GPP RATs.

In another embodiment, the communication device 160 is associated with the communication station 130 (an IEEE 802.11 wireless AP). The communication station 130 may transmit the interworking assistance information to the communication device 160 by utilizing MAC management messages or other suitable unicast communications of the IEEE 802.11 series RATs.

In another embodiment, the communication devices 160 and 170 are associated with the communication station 130 (an IEEE 802.11 wireless AP). The communication station 130 may transmit the interworking assistance information to the communication devices 160 by utilizing beacon frames, other suitable multicast communications or other suitable broadcast communications of the IEEE 802.11 series RATs.

In the operation 230, the communication device receives the interworking assistance information. The communication device may perform the cell selection operation, the cell re-selection operation, the handover operation or other interworking operations by associating with the neighboring communication station according to the interworking assistance information of the neighboring communication station. For example, the communication device 160 receives the interworking assistance information of the neighboring communication station 130 and 140 from the communication station 110. The communication device 160 may perform the interworking operations (e.g., handover from the communication station 110 to the communication station 140) according to the interworking assistance information of the neighboring communication station 130 and 140.

In one embodiment, the communication device 160 prefers handovering to a co-located communication station. Therefore, the communication device 160 may perform the handover operation according to the co-located indication information of the neighboring communication stations 130 and 140.

In another embodiment, the communication device 160 prefers associating with the neighboring communication station with a low latency link between the communication station 110 and the neighboring communication station. Therefore, the communication device 160 may perform the handover operation according to the backhaul link condition information of the neighboring communication stations 130 and 140.

In another embodiment, the communication device 160 prefers associating with the neighboring communication station whose operator is the same as the communication station 110. Therefore, the communication device 160 may perform the handover operation according to the operator information of the neighboring communication stations 130 and 140.

In another embodiment, the communication device 160 prefers associating with the neighboring communication station in the same security domain. Therefore, the communication device 160 may perform the handover operation according to the security information of the neighboring communication stations 130 and 140.

In another embodiment, the communication device 160 prefers associating with the neighboring communication station with a lower load. Therefore, the communication device 160 may perform the handover operation according to the loading condition information of the neighboring communication stations 130 and 140.

In another embodiment, the communication device 160 prefers associating with the neighboring communication station with a larger cell transmission range. Therefore, the communication device 160 may perform the handover operation according to the range information of the neighboring communication stations 130 and 140.

In another embodiment, the communication device 160 prefers associating with the neighboring communication station with a lower charging rate. Therefore, the communication device 160 may perform the handover operation according to the pricing information of the neighboring communication stations 130 and 140.

In another embodiment, the communication device 160 prefers associating with the neighboring communication station with the supported RAT, or the communication station 160 want to speed up the process of associating with the neighboring communication station. Therefore, the communication device 160 may perform the handover operation according to the network configuration information of the neighboring communication stations 130 and 140.

In the above embodiments, a communication station may transmit the interworking assistance information of the neighboring communication station to the communication device. The communication device may perform the interworking operations more wisely according to the interworking assistance information of the neighboring communication station(s).

Moreover, the communication stations utilizing the first RATs are usually heavily loaded, especially in the crowded area. The communication devices may switch to those communication stations utilizing the second RATs more efficiently according to the interworking assistance information of the neighboring communication station. The network traffic may be effectively offloaded to the lightly loaded communication stations, and a better load balancing performance of the network may be achieved.

In the drawings, the size and relative sizes of some elements may be exaggerated or simplified for clarity. Accordingly, unless the context clearly specifies, the shape, size, relative size, and relative position of each element in the drawings are illustrated merely for clarity, and not intended to be used to restrict the claim scope.

Certain terms are used throughout the description and the claims to refer to particular components. One skilled in the art appreciates that a component may be referred to as different names. This disclosure does not intend to distinguish between components that differ in name but not in function. In the description and in the claims, the term “comprise” is used in an open-ended fashion, and thus should be interpreted to mean “include, but not limited to.” The phrases “be coupled with,” “couples with,” and “coupling with” are intended to compass any indirect or direct connection. Accordingly, if this disclosure mentioned that a first device is coupled with a second device, it means that the first device may be directly or indirectly connected to the second device through electrical connections, wireless communications, optical communications, or other signal connections with/without other intermediate devices or connection means.

The term “and/or” may comprise any and all combinations of one or more of the associated listed items. In addition, the singular forms “a,” “an,” and “the” herein are intended to comprise the plural forms as well, unless the context clearly indicates otherwise.

Other embodiments of the invention will be apparent to those skilled in the art from consideration of the specification and practice of the invention disclosed herein. It is intended that the specification and examples be considered as exemplary only, with a true scope and spirit of the invention indicated by the following claims.

What is claimed is:

1. A communication station, comprising:
a transceiving circuit configured to operably communicate with a communication device by utilizing a first radio access technology (RAT);
a memory circuit configured to operably store one or more interworking assistance information of a neighboring communication station; and
a processing circuit, coupled with the transceiving circuit and the memory circuit, configured to operably configure the transceiving circuit to transmit the interworking assistance information of the neighboring communication station when the communication device is associated with the communication station;
wherein the neighboring communication station communicates with the communication device by utilizing a second RAT; at least part of a communication range of the communication station overlaps at least part of a communication range of the neighboring communication station;
and the interworking assistance information of the neighboring communication station comprises at least one of a co-located indication information, a backhaul link condition information, an operator information, a security information, a loading condition information, a range information, a pricing information and a network configuration information.

2. The communication station of claim 1, wherein the communication station transmits the interworking assistance information of the neighboring communication station to the communication device for assisting at least one of the following interworking operations of the communication device: a cell selection operation of the neighboring communication station, a cell re-selection operation of the neighboring communication station, and a handover operation from the communication station to the neighboring communication station.

3. The communication station of claim 1, wherein the communication station transmits the interworking assistance information of the neighboring communication station to the communication device by utilizing unicast communications.

4. The communication station of claim 1, wherein the communication station transmits the interworking assistance information of the neighboring communication station to the communication device by utilizing at least one of multicast communications and broadcast communications.

5. The communication station of claim 1, wherein the co-located indication information indicates whether the neighboring communication station is able to communicate by utilizing both the first RAT and the second RAT.

6. The communication station of claim 1, wherein the operator information indicates at least one of an interworking agreement information between the communication station and the neighboring communication station, and an operator of the neighboring communication station.

7. The communication station of claim 1, wherein the load condition information indicates at least one of a load condition of the neighboring communication station, a supported Quality of Service type of the neighboring communication station, and a communication station suggestion information.

8. The communication station of claim 1, wherein the range information indicates at least one of a geographical relationship between the communication station and the neighboring communication station, a transmission range information of the neighboring communication station, and a cell type of the neighboring communication station.

9. The communication station of claim 1, wherein the network configuration information indicates at least one of a carrier frequency, a channel information, a supported radio access technology, an identification, a timing information and a frame configuration of the neighboring communication station.

10. The communication station of claim 1, wherein the first RAT is chosen from one of wireless wide area network radio access technologies and wireless metropolitan area network radio access technologies, and the second RAT is chosen from one of wireless local area network radio access technologies

11. The communication station of claim 1, wherein the first RAT is chosen from one of wireless local area network radio access technologies, and the second RAT is chosen from one of wireless wide area network radio access technologies and wireless metropolitan area network radio access technologies

12. A communication device, comprising:
a first transceiving circuit configured to operably communicate with a first communication station by utilizing a first radio access technology (RAT);
a second transceiving circuit configured to operably communicate with a second communication station by utilizing a second RAT; and
a processing circuit, coupled with the first transceiving circuit and the second transceiving circuit, configured to operably configure the first transceiving circuit to receive one or more interworking assistance information of the second communication station from the first communication station when the communication device is associated with the first communication station;
wherein at least part of a communication range of the first communication station overlaps at least part of a communication range of the second communication station; and the interworking assistance information of the second communication station comprises at least one of a co-located indication information, a backhaul link condition information, an operator information, a security information, a loading condition information, a range information, a pricing information and a network configuration information.

13. The communication device of claim 12, wherein the processing circuit configures the second transceiving circuit to associate with the second communication station according to the interworking assistance information of the second communication station.

14. The communication device of claim 13, wherein according to the interworking assistance information, the processing circuit performs at least one of the following interworking operations: a cell selection operation of the second communication station, a cell re-selection operation of the second communication station, and a handover operation from the first communication station to the second communication station.

15. The communication device of claim 12, wherein the first transceiving circuit receives the interworking assistance information of the second communication station from the first communication station by utilizing unicast communications.

16. The communication device of claim 12, wherein the first transceiving circuit receives the interworking assistance information of the second communication station from the first communication station by utilizing at least one of multicast communications and broadcast communications.

17. The communication device of claim 12, wherein the co-located indication information indicates whether the neighboring communication station is able to communicate by utilizing both the first RAT and the second RAT.

18. The communication device of claim 12, wherein the operator information indicates at least one of an interworking agreement information between the communication station and the neighboring communication station, and an operator of the neighboring communication station.

19. The communication device of claim 12, wherein the load condition information indicates at least one of a load condition of the neighboring communication station, a supported Quality of Service type of the neighboring communication station, and a communication station suggestion information.

20. The communication device of claim 12, wherein the range information indicates at least one of a geographical relationship between the communication station and the neighboring communication station, a transmission range information of the neighboring communication station, and a cell type of the neighboring communication station.

21. The communication device of claim 12, wherein the network configuration information indicates at least one of a carrier frequency, a channel information, a supported radio access technology, an identification, a timing information and a frame configuration of the neighboring communication station.
